(19) United States
(12) Patent Application Publication
(10) Pub. No.: US 2004/0044731 A1
(43) Pub. Date: Mar. 4, 2004

(54) System and method for optimizing internet applications

(76) Inventors: Kailai Chen, Morganville, NJ (US); John Gnip, Rego Park, NY (US); Richard Dubilier, Dobbs Ferry, NY (US); Michael Corcoran, Burnaby (CA)

Correspondence Address: FULBRIGHT & JAWORSKI, LLP, 666 FIFTH AVE, NEW YORK, NY, 10103-3198, US

(21) Appl. No.: 10/396,195

(22) Filed: Mar. 24, 2003

Related U.S. Application Data
(63) Continuation-in-part of application No. 10/332,811, filed on Jan. 13, 2003.
Application No. 10/332,811 is a 371 of international application No. PCT/CA01/00100, filed on Jan. 29, 2001.
(60) Provisional application No. 60/366,887, filed on Mar. 22, 2002.

(51) Int. Cl. G06F 15/16

(52) U.S. Cl. 709/203

(57) ABSTRACT

A method and system for optimizing Internet applications. A centralized cache server connected to a plurality of web servers provides a cached copy of the requested dynamic content if it is available in its cache. Preferably, the centralized cache server determines if the cached copy is still fresh. If the requested content is unavailable from its cache, the centralized cache server directs the client request to the application server. The response is delivered to the client and a copy of the response is stored in the cache by the centralized cache server. Preferably, the centralized cache server utilizes a pre-determined caching rules to selectively store the response from the application server.

### CROSS-REFERENCE TO RELATED APPLICATIONS

This application is a continuation-in-part application of U.S. Provisional Patent Application Serial No. 60/366,887, filed Mar. 22, 2002 and U.S. patent application Ser. No. 10/332,811, filed Jan. 13, 2003, which is a national stage application of International Application No. PCT/CA01/00100, filed Jan. 29, 2001, which are incorporated in their entirety.

### TECHNICAL FIELD OF THE INVENTION

This invention relates to the delivery of data by way of computer networks, such as the Internet. The invention may be applied to the delivery of web pages from a web server to web clients. The invention has particular application in delivering dynamically updated web pages from a server to client computers.

### BACKGROUND OF THE INVENTION

It is becoming increasingly common to make information in a database available by way of the Internet. Users have computing devices (which may be personal computers, web-enabled devices, or the like) which are connected to the Internet. The users direct requests for data from the database to a server that has access to the database. The server makes an appropriate query of the database to retrieve the requested information and then generates a web page that contains the requested information. The server then delivers the web page to the user. Such systems may use server software such as Microsoft's Internet Information Server (“IIS”) or Apache™ Server from the Apache Software Foundation of Forest Hill, Md., U.S.A. to process and deliver user requests for information.

One difficulty faced by designers of systems for delivering information by way of the Internet or other computer networks is that such systems can become overloaded when they receive a very high volume of user requests. This is particularly a problem when each user request requires a processor in a server to query a database or to conduct other processor-intensive activities. Web servers servicing requests for static pages for which the only processing required is to locate and forward the requested static pages can process requests much more quickly than web servers servicing requests for dynamic data.

It is known that one can use a proxy server to reduce the load on a web server. Typically, the proxy servers or static cache servers are placed on the edge of the network at geographically dispersed locations to reduce network latency. Proxy server stores copies of static pages from web server and intercepts requests for those pages before the requests reach the web server. The proxy server services those requests by supplying copies of the requested pages. Traffic on the server is reduced because a number of requests never reach the server. Proxy servers can typically be used only for “static” content. Thus a conventional proxy server cannot be used conveniently to reduce the load on a server which is delivering dynamic content, such as information which is retrieved from a database. One can increase the rate at which requests for dynamic data can be handled by adding additional servers or using more powerful servers. This can be undesirably expensive, however.

Another problem with proxy servers is that it is desirable to keep accurate statistics regarding the number of requests received and processed for specific information. When these statistics are collected at a server and requests are handled by a proxy server then the statistics may be inaccurate because requests handled by the proxy server may not be counted at the server.

With the increasing amount of dynamic data being made available on the Internet and other networked computer systems there is a need for efficient ways to quickly handle requests for dynamic data.

### SUMMARY OF THE INVENTION

This invention provides methods and apparatus for servicing requests for dynamic data. In accordance with an embodiment of the present invention, a computer-implemented method is provided for optimizing web servers, comprising the steps of receiving a request for dynamic content a web server, sending the request to a centralized cache server for determining whether a copy of the dynamic content is available from a cache, receiving a cached copy of the dynamic content if the dynamic content is present in the cache, transmitting the request to an application server if the dynamic content is unavailable from the cache, receiving a copy of the dynamic content from the application server by the web server; transmitting the copy of the dynamic content to the centralized server for storing in the cache.

In accordance with an embodiment of the present invention, a computer-implemented method is provided for satisfying requests for dynamic data. The method comprises: receiving a request for dynamic data; determining whether a copy of the requested dynamic data is present in a cache data store; if a copy of the requested dynamic data is present in the cache data store, modifying the request to request the copy of the dynamic data in the cache data store and passing the request to a server; and, if a copy of the requested dynamic data is not present in the cache data store, requesting the dynamic data from a server, receiving a copy of the dynamic data from the server and storing the copy of the dynamic data in the data store.

In accordance with an embodiment of the present invention, there is at least one rule defining one or more types of requests for data which are permitted to be filled from the cache data store and the method includes checking the request for dynamic data to determine whether the request for dynamic data is of a type which is permitted to be filled from the cache data store and, if not, passing the request to the server. The server may comprise a web server and the request for dynamic data may be an HTTP request.

Another aspect of the invention comprises apparatus for satisfying requests for dynamic data. The apparatus comprises a computer running software, the software including instructions which, when run by the computer, cause the computer to: receive a request for dynamic data; determine whether a copy of the requested dynamic data is present in a cache data store; if a copy of the requested dynamic data is present in the cache data store, modify the request to request the copy of the dynamic data in the cache data store and pass the request to a server; and, if a copy of the requested dynamic data is not present in the cache data store, request the dynamic data from a server, receive a copy of the dynamic data from the server and store the copy of the dynamic data in the data store.

Yet another aspect of the invention provides a computer readable medium comprising instructions which, when executed by a computer, cause the computer to perform a method for satisfying requests for dynamic data. The method implemented by the computer executing the instructions comprises: receiving a request for dynamic data; determining whether a copy of the requested dynamic data is present in a cache data store; if a copy of the requested dynamic data is present in the cache data store, modifying the request to request the copy of the dynamic data in the cache data store and passing the request to a server; and, if a copy of the requested dynamic data is not present in the cache data store, requesting the dynamic data from a server, receiving a copy of the dynamic data from the server and storing the copy of the dynamic data in the data store.

Other features and advantages of this invention are described below. The terms SPIDERCACHE™ and SPIDERCLIENT™, which appear in this disclosure and the accompanying drawings are a trademark of the assignee of this invention.

### BRIEF DESCRIPTION OF DRAWINGS

FIG. 1 is a schematic block diagram illustrating a system in accordance with an embodiment of the present invention;

FIG. 2 is a block diagram illustrating the relationship between software components of an exemplary implementation of the present invention;

FIG. 3 is a flow chart describing the dynamic web page caching process in accordance with an embodiment of the present invention;

FIG. 4 is a schematic block diagram illustrating a system in accordance with an embodiment of the present invention; and

FIG. 5 is a flow chart describing the process of optimizing Internet applications in accordance with an embodiment of the present invention.

### DESCRIPTION OF THE INVENTION

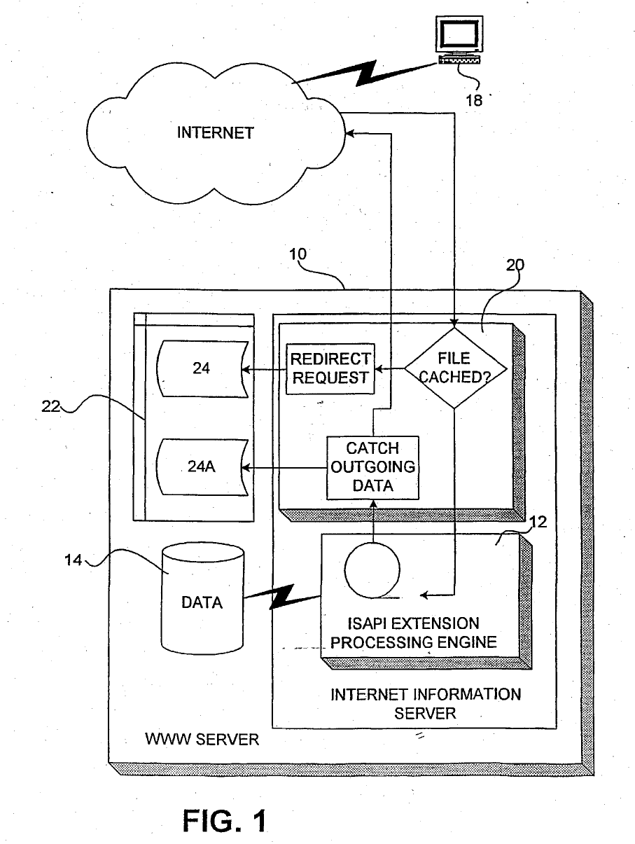

In accordance with an embodiment of the present invention, FIG. 1 illustrates the dynamic web page caching system comprising a web server computer 10 running web server software 12 such as Microsoft Internet Information Server or Apache Server. The web server software 12 is capable of retrieving information from a database 14 in response to requests received from client computers 18 by way of a network 16, such as the Internet, an intranet or the like. The requests are most typically in the form of HTTP (HyperText Transfer Protocol) requests.

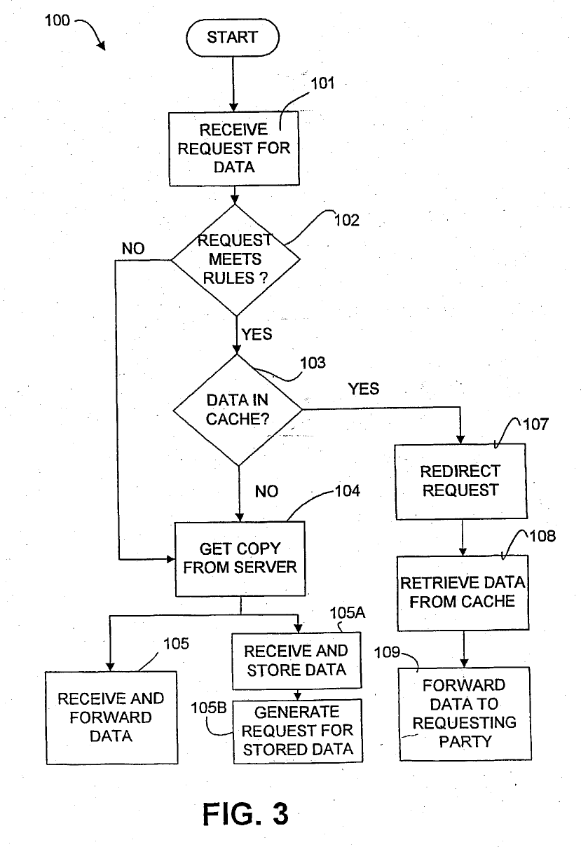

Cache software 20 runs on a computer, which may be a web server 10, which is in a data path between the web server 10 and the client computers 18. The cache software 20 has access to a data store 22 that contains cached files 24. The data store 22 may comprise a storage device, a memory area or the like. The process of dynamic web page caching in accordance with an embodiment of the present invention is now described in conjunction with FIGS. 1 and 3. The cache software 20 inspects requests for data that are directed to the server software 12 at step 101. The cache software 20 determines whether the requested data resides in a cached file 24 in the data store 22 at step 103. If so, then instead of passing the request directly to the server software 12, the cache software 20 modifies the request to point to the cached data file 24 at step 108 and then passes the modified request to the web server 10. The web server 10 then accesses the cached data in the data store 22 and returns to the requesting computer 18 data from the cached file 24 at step 109.

If the requested data is not cached in the data store 22 then the cache software 20 forwards the request to the server software 12 at step 104. The server software 12 processes the request by querying the database 14 and returns data resulting from the query to the computer 18 in response to the request. The cache software 20 receives and saves as a cached file 24A in the data store 22 a copy of the outgoing data. In some embodiments, cache software 20 receives the outgoing data and then forwards the outgoing data to the requesting party at step 109. In other embodiments, the cache software 20 receives the outgoing data, stores the outgoing data in the data store 22 at step 105A and then prompts the server software 12 to forward the cached data from the data store 22 to the requesting party at step 105B.

If the cache software 20 subsequently receives another request for the same data then the cache software 20 can modify the request to a request for the copy of cached file 24A. The server software 12 can process this request in much less time than it would take to query the database 14 to recreate the data in cached file 24A. The load on the web server 10 is reduced since the cache software 20 relieves the web server 10 from processing any request that can be satisfied by providing a file cached in the data storage 22. Preferably (to conserve space in the data store 22) the cached files 24 are compressed. As a simple example, the compressed files may be HTML files with white spaces and/or comments removed.

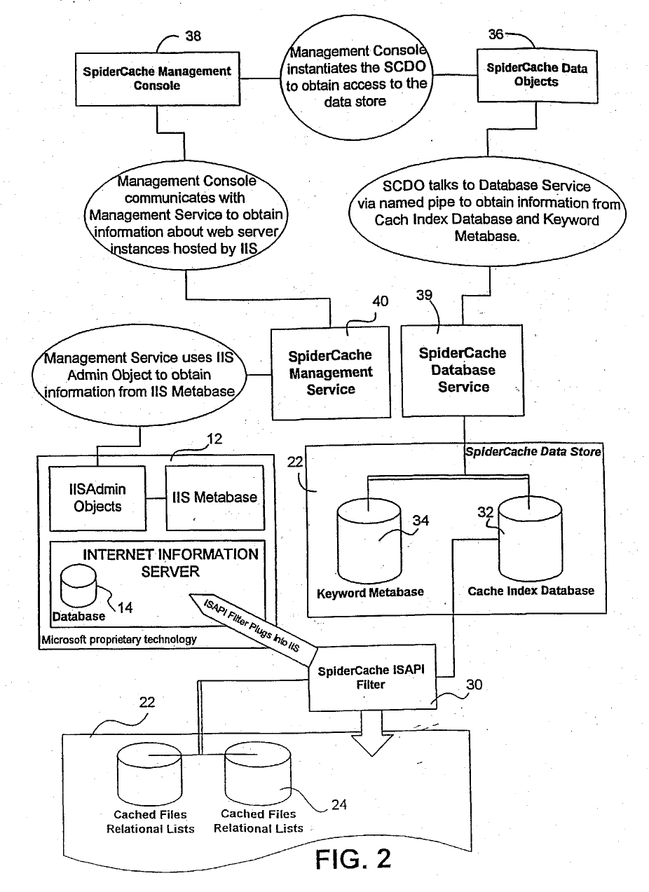

As shown in FIG. 2, in accordance with an embodiment of the present invention, the cache software 20 is provided in the form of a “plug-in” which can attach itself to web server software such as Microsoft's IIS via an Internet Server Application Programming Interface (ISAPI) Filter 30. The ISAPICACHE DLL accomplishes this by exporting three procedures—GetFilterVersion, HttpFilterProc and TerminateFilter. The ISAPI Filter 30 monitors all incoming requests to the web server 10 and identifies requests that have contents which match specific patterns at step 102. The content to be watched for by the filter 30 may be defined by the website developers and/or administrators. The filter 30 may provide a series of rules which define queries which may be satisfied by cached data from the data store 22 and/or queries which cannot be satisfied by supplying cached data from the data store 22. Content that is not recognized as requiring handling by the cache software 20 may be simply passed to web server software 12 for processing by the web server software 12.

The ISAPI Filter framework for IIS is described in “Developing ISAPI Filters”. This document can be found at http://msdn.microsoft.com/library/psdk/iisref/isgu3vn7.htm. The complete contents of this document, as of the filing date of this application is incorporated by reference herein.

For example, a file called “Stories.asp” may be defined as a file that should be cached by the cache software 20. If the filter 30 receives a request from a user for the file Stories.asp for viewing at a client computer 18, the filter 30 identifies and flags that incoming request for further processing. If the filter 30 determines that the request for “stories.asp” can be satisfied from data in the data store 22 then the filter 30 may supply the cached file 24 to the user instead of passing the request for processing by the web server software 12. If the filter 30 determines that the request for “stories.asp” cannot be satisfied by supplying a file from the data store 22 then the filter 30 passes the request to the server software 12. The server software 12 then processes the request for Stories.asp. This may involve database queries and/or dynamic content generation. The server software 12 then sends back the generated page to the user.

Because the filter 30 has identified the request for stories.asp as requiring special handling, the filter 30 captures the reply which the server software 12 generates and writes a copy of the reply to the data store 22. The next time the user requests “stories.asp,” the cache software 20 redirects the request to the cached file 24, thus making it unnecessary for the server 12 to regenerate the file.

### EXAMPLE 1

### Implementation for use with Microsoft's IIS

A specific embodiment of the invention includes cache software 20 developed using Borland's Delphi 4.0 software development environment. This embodiment of the cache software 20 runs in the Microsoft Windows environment. The cache software 20 includes multiple modules that run independently of each other, but communicate with one another other. Table I lists primary components of a current version of the cache software 20. A primary functioning module of this embodiment of the cache software 20 is the IsapiCache DLL. This DLL plugs into the Microsoft Internet Information Server as an Internet Server Application Programming Interface (ISAPI) Filter. As is known to those skilled in the art, the IIS architecture allows the integration of DLLs into its ISAPI Filter framework.

TABLE 1
COMPONENTS OF CACHE SOFTWARE

| NAME | DESCRIPTION |
|---|---|
| IsapiCache.dll | Provides caching functions |
| SCNTService.exe | Window NT application that runs on a web |
| | server. Acts as a listener for a client |
| | application to perform database management |
| | and cache operation. |
| SCDO.dll0 | A data object. Preferably a COM/ActiveX |
| | object that provides a convenient interface to |
| | data affecting the operation of cache software |
| | 20. Can also be used to provide cache |
| | maintenance commands to management |
| | service 40. |
| SpiderClient.exe | A front-end user interface that allows |
| | administration of cache software 20 and the |
| | database of cache software 20. |

The ISAPI Filter (IsapiCache.dll) is registered with IIS by adding a ‘node’ to the IIS Metabase. When IIS loads IsapiCache.dll, IIS asks IsapiCache what IIS events IsapiCache would like to be notified of. In the example embodiment described herein, IsapiCache requests that IIS provide notifications about seven IIS events. These events are indicated by the constant values set out in Table II that are passed to IIS during load time. In the processing of a typical HTTP request the listed events occur in the listed order.

TABLE II
EVENTS

| Constant | Description |
|---|---|
| SF_NOTIFY_PREPROC_HEADERS | A single |
| | SF_NOTIFY_PREPROC_HEADERS |
| | notification will occur for each request. This |
| | notification indicates that the server has |
| | completed pre-processing of the headers |
| | associated with the request, but has not yet |
| | begun to process the information contained |
| | within the headers. |
| SF_NOTIFY_URL_MAP | A SF_NOTIFY_URL_MAP notification will |
| | occur after the server has converted the |
| | virtual URL path contained in the HTTP |
| | request into a physical path on the server. |
| | Note that this event may occur several times |
| | for the same request. |
| SF_NOTIFY_SEND_RESPONSE | The SF_NOTIFY_SEND_RESPONSE event |
| | occurs after the request is processed and |
| | before headers are sent back to the client. |
| SF_NOTIFY_SEND_RAW_DATA | As the request handler returns data to the |
| | client, one or more |
| | SF NOTIFY_SEND_RAW_DATA |
| | notifications will occur |
| SF_NOTIFY_END_OF_REQUEST | At the end of each request, the |
| | SF_NOTIFY_END_OF_REQUEST |
| | notification occurs. |
| SF_NOTIFY_LOG | After the HTTP request has been completed, |
| | the SF_NOTIFY_LOG notification occurs |
| | just before IIS writes the request to the IIS |
| | log. |
| SF_NOTIFY_END_OF_NET_SESSION | When the connection between the client and |
| | server is closed, the |
| | SF_NOTIFY_END_OF_NET_SESSION |
| | Notification occurs. If a Keep-Alive has |
| | been negotiated, it is possible that many |
| | HTTP requests occur before this notification |
| | occurs. |

The cache software 20 causes the computer on which it is running to perform various actions. IsapiCache.dll handles the SF_NOTIFY_PREPROC_HE-ADERS event. When this event occurs, computer instructions in IsapiCache.dll cause the computer on which IsapiCache.dll is running to examine the incoming HTTP request. It finds the resource that the request is looking for, and then checks that against its Cache Index Database 32 to determine whether the requested resource is flagged for caching. If the resource is NOT flagged for caching then, IsapiCache extracts itself from the rest of the request process (i.e., no more SF_NOTIFY notifications for this request occurs). If the resource is flagged for caching then IsapiCache checks its cache of files to see if the requested resource is already cached. If the requested resource is already cached, then IsapiCache redirects the request to the cached resource and extracts itself from the rest of the request process.

In accordance with an embodiment of the present invention, the cache software 20 provides a facility which permits an administrator to specify rules which will determine whether or not files will be cached based upon custom settings including HTTP header information, cookie information, and, query string information. Whether or not a specific resource is cached is conditional depending upon whether the request satisfies the rules.

If the requested resource is flagged for caching but is NOT cached, then IsapiCache attaches some data to the request to allow itself to follow the request through the request process.

IsapiCache extracts the requested resource by asking IIS for the Universal Resource Locator (URL) within the HTTP request header. IsapiCache parses the returned information to find the QueryString, the FileName and the Path. For example: a URL equal to /home/products/spidercache.asp?id=29 would be parsed as QueryString: id=29, FileName: spidercache.asp, Path:/home/products/

IsapiCache then uses this information to extract itself from the request process if possible by comparing the file extension of the FileName against a list of cacheable file extensions to see if it can ignore the request. If the FileNames file extension is in the list, IsapiCache does a lookup in its Cache Index Database 32 to see if the file should be cached (i.e., the administrator has specified this file as one to cache).

If IsapiCache does not find a match in the Cache Index Database 32, it removes itself from the request process. If it finds a match, it accesses the caching properties and settings for this individual file from the Cache Index Database 32 to use in a comparison algorithm to see if the requested resource has already been cached. IsapiCache examines the cache file settings to first see if the resource is set to cache based on the QueryString value only, or if it is set for custom caching via the “Parameterized Caching” technology. If the setting specifies that the file is cached based on query string only, IsapiCache searches the cache index database 32 to find a file in the data store 22 which corresponds to a matching query string value. If IsapiCache finds a match it redirects the user's request to the cached file.

If the setting specifies that the file is cached based on parameterized caching, IsapiCache compares the parameterized caching requirements to rules specified by the administrator for this file (the rules may include, for example conditions on query string, header and cookie values that must equal certain values or ranges of values, must not equal certain values or ranges of values or must not exist) with the information that is found in a “Cached Files Relational List” for the requested file. If a match is found, IsapiCache redirects IIS to the cached resource and removes itself from further participation in the IIS request process for that resource.

In some cases different data should be returned in response to the same query string depending upon the values of header fields or cookie values. If only the query string were used to identify cached data, the wrong data might be returned in some circumstances. For example, it may be desired to provide data that differs somehow in response to the geographical location of the user or the web browser software being used by the user. Parameterized caching may be used to ensure that the correct data is cached and delivered. Parameterized caching may be used, for example, to cache files based on the location or identity of the user or agent (as identified in the header accompanying a request), to cache files based on the language of the requested resource, or the like.

If a match cannot be found in any of the above situations, IsapiCache proceeds following the request through the IIS request process and caches the requested resource during the SF_NOTIFY_SEND_RAW_DATA event, as described below.

IsapiCache processes the SF_NOTIFY_URL_MAP event. IsapiCache uses this event to notify itself of any files that are ‘included’ within the requested resource. IsapiCache keeps any included file paths in memory for use later on in the request process.

IsapiCache.dll handles processing of the SF_NOTIFY_SEND_RESPONSE event. When IsapiCache.dll is notified of the occurrence of the SF_NOTIFY_SEND_RESPONSE event then IsapiCache.dll examines the ‘Transfer-Encoding:’ response header to determine if the response is ‘CHUNKED’ or not.

IsapiCache.dll handles processing of the SF_NOTIFY_SEND_RAW_DATA event. When IsapiCache.dll is notified of the occurrence of the SF_NOTIFY_SEND_RAW_DATA event it caches the requested resource for use in servicing subsequent requests for the same resource. This event occurs repetitively until all data, in response to the request, has been sent to the requester. IsapiCache writes all of the outgoing data to the data store 22 at an appropriate cache location. Preferably, the cache software 20 can recognize in the data symbols that signify portions of the data which should not be cached. When such symbols are present in the data being returned by server software 12, IsapiCache.dll detects the symbols and does not cache portions of the data that are flagged for ‘NO CACHE’. The symbols may include a symbol indicating the start of a portion of the data that should not be cached and an end of the portion of the data that should not be cached. Preferably the cache software 20 permits individual files to be identified as files which should not be cached. This permits an operator to temporarily stop a selected file or resource from being cached without affecting other settings.

This is also where ‘included’ files are used. If the outgoing data includes a section of code that is flagged for ‘NO CACHE’, IsapiCache attempts to identify a file that contains suitable source code, such as HTML source code, ASP. (active server pages), CGI (common gateway interface), PHP, JSP (java server pages) or other scripting language, for generating the data in the NO CACHE section. This code may be in one of the included files. If IsapiCache can find the source code, then IsapiCache writes the source code to disk, rather than the outgoing data. This permits pages to be semi-cached. P arts of the page remain dynamic, while the rest is cached.

For example, in accordance with an embodiment of the present invention, as the SF_NOTIFY_SEND_RAW_DATA event occurs IsapiCache intercepts and examines the outgoing data for specific flags that trigger specific processing under the control of the IsapiCache DLL. Some different types of flags that may be encountered during this process are: 1) The ‘End Of File Header’ flag; 2) The ‘Begin No Cache’ and ‘End No Cache’ flags; 3) The ‘Begin Script’ and ‘End Script’ flags; and, 4) The ‘End Of File Marker’ flag.

The End Of File Header flag is signified by the following syntax within an HTML document: <!—sc:end file header—>. IsapiCache only recognizes this flag if it is in the first response stream sent out by IIS after IIS has returned the response HTTP header. It is used to tell IsapiCache to include in the cached file all source code from the original source file that exists before the same flag in the source file.

The ‘Begin No Cache’ and ‘End No Cache’ flags can exist anywhere within the source file, including included files (using the #include directive), and is used to signal IsapiCache to stop caching the outgoing data stream and instead search the source files (files is plural here because of the possibility of included files using the #include directive) for the matching flags and extract the source code and cache from those file(s) instead. The end result is that, in the cached file, there is source code (which may be HTML source code or source code in another scripting language) that was extracted from the original source file before IIS processed it.

The ‘Begin Script’ and ‘End Script’ flags may also appear anywhere within the source file and are used to signal IsapiCache to modify the data it writes to the cached files. For example, if the ‘Begin Script’ flag is ‘<!—sc:begin script’, then IsapiCache will replace the occurrence of ‘<!—sc:begin script’ with (excluding single quotes) a delimiter as specified by the BeginScriptDelimiter setting. If ‘sc:end script—>’ is the ‘End Script’ flag, then IsapiCache will replace the occurrence of ‘sc:end script—>’ with (excluding single quotes) a delimiter as specified by the EndScriptDelimiter setting. For example, the BeginScript delimiter could be ‘<%’ followed by a number of space characters, and the EndScript delimiter could be a number of space characters followed by (excluding single quotes) ‘%>’. This allows for new code that was not present in the original source file, to exist in the cached file. The BeginScriptDelimiter and EndScriptDelimiter settings are preferably associated with the target file. For example, in the currently preferred embodiment, these settings are located in the Cache Index Database and associated with the target file. Different script delimiters can be selected for use with different programming languages.

The ‘End Of File Marker’ flag is placed at the end of the file and is used to indicate that the file was executed successfully and was fully processed. The theory is that if the file was executed without errors by IIS, and the End Of File Marker is found in the response stream sent back to the requester, then the IsapiCache filter can assume that the cached file is valid. The End Of File Marker is specified in the EOF Marker Setting in the Cache Index Database.

IsapiCache handles processing of the SF_NOTIFY_END_OF_REQUEST event. On the occurrence of this event, IsapiCache closes open file handles and dispose of the allocated memory occupied by the ‘included’ files.

The IsapiCache.dll processes the SF_NOTIFY_LOG event. This event is triggered when IIS is about to log information to the website log files. Preferably the caching software 20 can be configured to either log the requests made of the web server software 12 or to log the source of the data used to fulfil those requests (including requests that have been redirected by the caching software 20).

The IsapiCache.dll processes the SF_NOTIFY_END_OF_NET_SESSION event. On the occurrence of this event, IsapiCache cleans up any resources used during the request process (i.e., releases memory).

In accordance with an embodiment of the present invention, the caching software 20 provides an interface that allows administrators to control and customize its operation. This may be accomplished, for example, by implementing Windows NT services that allow the configuration and management of the resources provided by the cache software 20.

A cache software management service provides multi-threaded access to the configuration, settings and properties of both the cache software 20 and the server software 12, as well as the files and virtual path information managed by the server software 12. This service opens a Named Pipe to communicate with multiple clients by creating new threads to service those clients.

A Database Service provides multi-threaded access to the Index Database 32 of cache software 20 as well as a Keyword Metabase 34. This service opens a Named Pipe to communicate with multiple clients by creating new threads to service those clients. This service provides access to a central data store of cached resource properties and settings. Cache Index Database 32 and Keyword Metabase 34 preferably have a variable field length database format.

Management may be provided by manipulating properties of a cache software Data Object (SCDO) 36 and a management console 38. A current version of the cache software 20 provides eight (8) COM objects for the management of the cache and cached file settings and properties. These COM Objects open a Name Pipe to the Database Service 39 to gain access to the Cache Index Database 32 located on a given server. The SCDO Objects 36 are a primary method of accessing the Cache Index Database 32.

The Management Console 38 is provided to configure all settings and properties of the cache software 20 via a Graphical User Interface. All data, settings and properties are kept in a central location on the server. Management Console 38 accesses the information it requires from Data Objects 36 and Management Service 40 using Named Pipes.

The Management Console 38 connects to the Management Service 40 to receive appropriate information regarding the Server settings, IIS configuration and files. The Management Console also uses the SCDO Objects 36 to gain access to the Cache Index Database 32 which holds all information about the website resources that are flagged for caching.

### EXAMPLE 2

Apache Server Implementation. The invention may be implemented in the Apache Server environment by providing cache software in the form of a module, which is accessible to Apache Server. The module may be corn piled right into the Apache Server executable code or, in the alternative, may act as an external executable that Apache can load dynamically, when necessary.

Apache Server is configured to refer certain types of request to the cache software module. This may be done by including in the Apache Server configuration file a directive that causes the caching software module to be the handler for certain types of request.

When the caching software module is notified of a request by the Apache Server, it checks to see if it has previously cached the requested data. If the cache software has a cached instance of the requested data the n it per forms an Apache internal redirect to the cached file without affecting other Apache operations (such as logging). After this action has been taken then the cache software module is dropped from the request process. Apache handles the request by returning the cached instance to the requesting party.

If the cache software does not have a cached instance of the requested data, then the cache software creates a “sub-request” (as described in the Apache technical documentation which can currently be found on-line at http://www.apache.org) for the requested information. The sub-request is processed by the Apache Server (using whatever module is the appropriate handler for the request) in the same manner that it would be if the cache software were not present. The requested information is then returned to the caching software without sending any data to the requesting user. When the cache software module receives control of the request, it receives a data structure that contains the results of the request, as provided by the appropriate handler. The cache software then writes the results of the request to its cache and proceeds as described above for the case where the caching software has a cached file for the given request.

The cache software 20 may be configured to permit the use of a cached file only within a certain time period after its creation. For example, a cached file may be kept available only for 1 week, 1 day, 2 hours, 3 minutes, or the like. Preferably, expiration times may be associated with individual cached files. This permits the expiration time to be se t with reference to the type of file in question or even with reference to an individual file.

It can be appreciated that, in accordance with an embodiment of the present invention, it is possible to correctly log requests for resources from the server even if some of those requests are redirected by cache software 20 to a previously stored file. Further, in accordance with another embodiment, the cache software 20 does not itself make requests for information from server software 12. The cache software 20 intercepts data that has been generated by the server software 12 as a result of a request. Caching is not performed as a separate task in accordance with an embodiment of the present invention. This permits portions of pages or other resources to be cached while other portions are not cached. Providing cache software 20 as a “plug-in” makes it possible for cache software 20 to remove itself from the process of servicing a request for data, such as HTTP data, as soon as it becomes clear that there is a reason why cache software 20 no longer needs to be involved in respect of the request in question.

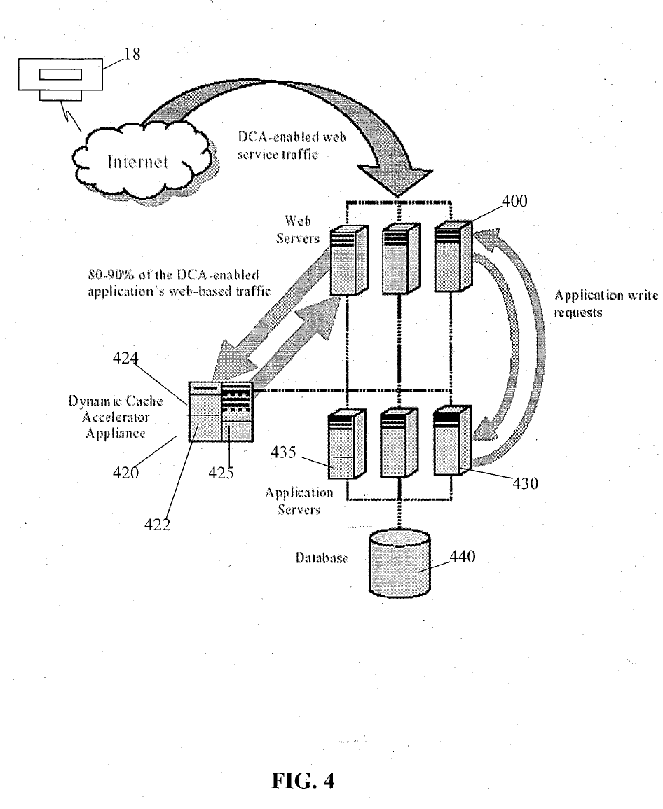

Turning now to FIG. 4, there is illustrated a system for optimizing Internet applications in accordance with an embodiment of the present invention. A centralized dynamic cache accelerator (DCA) server 420 having one or more caches 425 in accordance with an embodiment of the present invention is connected to one or more web servers 400 and one or more application servers 430. Alternatively, the cache 425 may reside in a separate cache server 450 connected to the DCA server 420. Each application server 430 is connected to one or more database servers 440. The web server 400 comprises a DCA plug-in 410 to provide a DCA enabled web server 400.

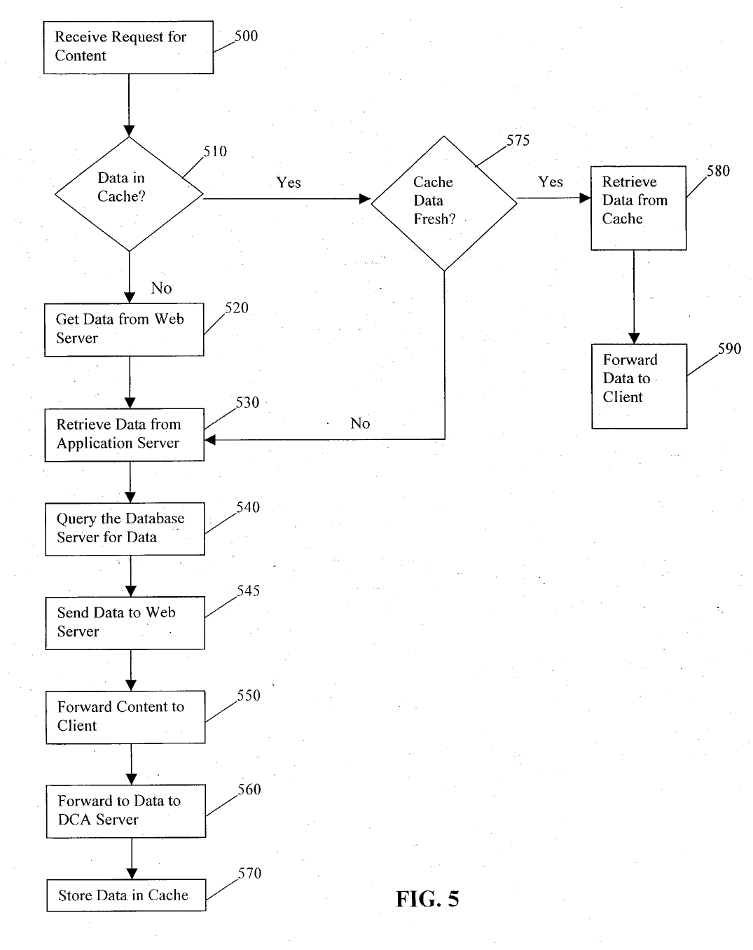

The process of optimizing Internet connections in accordance with an embodiment of the present invention is now described in conjunction with FIGS. 4 and 5. When a client or end-user makes a request to a web site (i.e., a DCA enabled web server 400) via client computer 18, the web server 400 sends the request for content or data to the DCA server 420 at step 500. If the DCA server 420 does not find the requested content in its cache 425 at step 510, the DCA server 420 sends the request back to the web server 400 at step 520. The DCA server 420 searches the cache index to determine if the requested content is in the cache 425. The web server 400 sends the request to the application server 430 to obtain the requested content at step 530. The application server 430 queries the database server 440 to obtain the requested content at step 540.

The application server 430 transmits its response (i.e., the requested content or data) to the web server 400 at step 545. The web sever 400 transmits the response to the client 18 at step 550. The DCA plug-in 410 intercepts the response and forwards the response to the DCA server 420 to be stored in its cache 425 at step 560. In accordance with an aspect of the present invention, the DCA plug-in 410 modifies the response before forwarding it to the DCA server 420. The modification does not affect what the end-user will see on a web browser running on its client computer 18. The modification instructs the DCA server 420 what to do with the content. For example, the modification may instruct the DCA server 420 to store the content in the cache 425 and check the content validity before serving subsequent request for the same content before at step 570.

As stated herein, the DCA server 420 may utilize cache rules established by web site provider to cache particular content (i.e., which web pages and objects should be cached and which ones should be ignored). However, not all web site owners may fully understand the kind of traffic their web sites encounter on a daily basis and may be unable to formulate cache rules to optimize their web sites. Accordingly, in accordance with an embodiment of the present invention, the DCA server 420 monitors the web site traffic (i.e., requests coming into the web server 400) to establish a recommended list of rules (i.e., dynamic rules) for the web site owner to optimize their web site. For example, DCA server 420 can monitor cookies, headers, URLs, all requests or a subset of requests that come into a particular web server 400 to determine what parameters are included in the URL, what web site pages (content) are being requested by the end-users, at what frequency, etc. A subset of request may be based on netpath or file extensions. The DCA server 420 orders the rules in the recommended list from highest to lowest. The operator or web site administrator/owner can accept all of the rules or select one or more desired rules from the recommended list of rules. Table 3 delineates an exemplary list of common commands that can be used in constructing cacheable rules in accordance with an embodiment of the present invention.

TABLE 3
Cacheable Rule Parameters

| Parameter | Definition |
|---|---|
| <abs_path> | The incoming netpath. In http://www.xyz.com/cgi-bin/ createLinks.pl?id=4, |
| | the abs_path would be /cgi-bin/ createLinks.p1 |
| <cacheable_rule_id> | Value must be unique (e.g. ruleid-01). |
| <method> | Can be GET or POST. |
| <secured> | Optional. If specified (“yes”), the cacheable rule will only be served if the |
| | request is authenticated (e.g. user has passed the application logon process). |
| <authenticationpage> | The value can be login or logout. |
| <sessiontime> | Optional. If specified, all authenticated session requests will be checked |
| | against this value. If it is within the time frame of the specified value then the |
| | content will be served, otherwise the request will be forwarded to the |
| | application server. |
| <max_age> | This can be used to automatically expire a page. This argument is the |
| | number of seconds the page should stay fresh before being invalidated. |
| <name> | The parameter name. In http://www.xyz.com/cgi-bin/ createLinks.p1?id=4, |
| | the name is id. |
| <value> | This is optional. If specified, the cacheable rule will only match if the |
| | incoming argument has this value. |
| <include> | This is only relevant for Optional and MustBePresent pages (see |
| | <cacheable>). If it is yes, the parameter will be included in the key used to |
| | cache the page. |
| <cacheable> | There are 3 possible values: |
| | 1) MustBePresent: The parameter must be included in the url string for the |
| | page to be cached. |
| | 2) MustNotBePresent: The parameter must not be included. If it is, the page |
| | will not be cached. |
| | 3) Optional: It doesn't matter whether or not the parameter is in the url |
| | string. If it is present, the <include> tag is used to determine whether or not |
| | it will be used in the cache key. |

The following is an example of cacheable rules formulated using the cacheable parameters of Table 3:

<cacheable_rule>

<abs_path>/cgi-bin/dca/realest.cgi</abs_path>
<cacheable_rule_id>realest</cacheable_rule_id>
<method>GET</method>
<secured>yes</secured>
<cookie_list>

<cookie>

<name>md</name>
<value>addform</value>
<include>no</include>
<cacheable>Optional</cacheable>

</cookie>

</cookie_list>
<header_list>

<header>

<name>md</name>
<value>addform</value>
<include>no</include>
<cacheable>MustNotBePresent</cacheable>

</header>

</header_list>
<argument_list>

<argument>

<name>md</name>
<include>yes</include>
<cacheable>MustBePresent</cacheable>

</argument>

</argument_list>
<content_rewrite_rule_list>

<content_rewrite_rule>

<response_netpath>cgi-bin/rewritten.cgi</response_net_path>

<binding>

<request_argument>md</request_argument>
<response_argument>ncm</response_argument>

</bindmg>

</content_rewrite_rule>

</content_rewrite_rule_list>
'</cacheable_rule>
<cacheable_rule>
<abs_path>/cgi-bin/login.cgi</abs_path>
<cacheable_rule_id>login</cacheable_rule_id>
<method>POST</method>
<authenticationpage>login</authenticationpage>
<sessiontime>10</sessiontime>

</cacheable_rule>
<cacheable_rule>

<abs_path>/cgi-bin/logout.cgi</abs_path>
<cacheable_rule_id>logout</cacheable_rule_id>
<method>POST</method>
<authenticationpage>logout</authenticationpage>

</cacheable_rule>

In accordance with an embodiment of the present invention, the DCA server 420 determines the rules based on various factors, such as average time and number or frequency of hits, etc. Time is defined as the time it takes the web server 400 to submit a request to the time it takes to receive the response from the application server 430. Hits are defined as the number of requests made for the same web page using the same inputs. Accordingly, the DCA server 420 calculates the number of hits on each unique entry and average (weight) time between hits.

However, if the DCA server 420 finds the requested content in its cache 425 (preferably, an entry for the requested content in the cache index) at step 510, the DCA server 420 sends the cache content (i.e., requested content or data) from its cache 425 to the web server 400 and the request is terminated at step 580. The web sever 400 transmits the response (i.e., cache content) to the client 18 at step 590. Preferably, if the DCA server 420 finds the requested content in its cache 425 at step 510, the DCA server 420 determines if the cache content is “still fresh” before transmitting the cache content to the web server 400 at step 575. If the DCA server 420 determines that the requested or cached content is still fresh at step 575, then the DCA server 420 sends the cached content from its cache 425 to the web server 400 at step 580. If the DCA server 420 determines that the cached content is not “fresh” at step 575, the DCA server 420 sends the request back to the web server 400 at step 530 and the process proceeds through steps 540-570 as though the requested content is unavailable from the cache 425.

In accordance with an embodiment of the present invention, the DCA server 420 monitors or tracks the freshness of the cached content. The cached content becomes “stale” generally when its underlining data is changed. This underlining data can change due to an end-user request or a database related event. The content residing in the DCA server 420 must be kept in sync with the application server 430. When the content is updated on the application server 430, the DCA server 420 must be informed so that “stale” content stored in the cache 425 is invalidated and replaced with “fresh” content. Accordingly, the DCA server 420 tracks the freshness of the cached content by monitoring these kinds of activities. When the DCA server 420 detects such a request/event, the DCA server 420 invalidates any cached content that depends on such underlying data. Preferably, the DCA server 420 can also determine or predict future usage of particular web page or content based on monitoring of these activities, thereby enabling the DCA server 420 to store or “push” these web pages or content in its cache 425. This feature can be configured to apply to content that will be likely used heavily in the near future, such as a breaking news event.

In accordance with an embodiment of the present invention, the DCA server 420 can cache content and invalidate the cached content based on a set of rules established by the cache providers or content providers (i.e., web site owners). For example, the rules may represent event rules, which specify certain web, database or other events that invalidate cached content (e.g., web pages or objects). In accordance with an aspect of the present invention, the DCA server 420 includes an event listener 422, which receives and processes invalidation requests for invalidating a particular cached content. The event listener 422 can be a process residing in the DCA server 420 which monitors the database servers 440 to detect any changes in the database that may trigger cache invalidation, such as a write request that may change the underlying data of the cached content. The system administrator can submit invalidation requests to the event listener 422 to clean up the entire cache 425 in emergency (i.e., invalidate all cache entries) or to invalidate a particular cache content in an ad hoc manner. For example, the invalidation request can be an XML document sent over HTTP using HTTP/1.1 POST method. The body of the POST content can be a valid XML document, in which a list of one or more invalidation object is given. For example, if the objective is to let the cached objects expire automatically after a fixed time interval, then specify a maximum age using the cacheable rule. Upon receiving an invalidation request, the event listener 422 informs the DCA server 420 to invalidate the matching cached content or object. The DCA server 420 determines all matching cached content to be invalidated based on the dependency rules, such as URL, query parameters, http headers, http cookies and the like. That is, the DCA server 420 determines all cached content that depends on the underlying data corresponding to the invalidation request. Table 4 delineates an exemplary list of common commands that can be used in constructing validation rules in accordance with an embodiment of the present invention.

TABLE 4
Validation Rule Parameters

| Parameter | Definition |
|---|---|
| <abs_path> | Same as <cacheable rule> |
| <validation_rule_id> | A unique id used to represent a particular validation rule. |
| <validation_rule_type> | Must be one of the following types: a) invalidateall: all cache entries with this |
| | abs_path will be removed from the cache, regardless of any other parameters |
| | in the cache key; b) useinput: all parameters are taken directly from the URL |
| | string and used to invalidate cache entries; c) useparms: An<argument_list> |
| | must be provided and these arguments will be used to invalidate the cache. |
| <method> | Same as <cacheable rule> |
| <name> | Same as <cacheable rule> |
| <value> | Unused |
| <validation_value_type> | Used to specify how the value of this argument should match arguments with |
| | the same name in the cache. Can be one of the following types: a) all: match |
| | against any value; b) input: match using whatever value was provided in the |
| | incoming request; c) constant: Match with a constant value provided in |
| | <validation_value> |
| <validation_value> | Only used with a <validation_value_type> of constant. Allows a fixed value |
| | for an argument. |

The following is an example of validation rules formulated using the validation parameters of Table 4:

<validation_rule>

<abs_path>/cgi-bin/dca/realest.cgi</abs_path>
<validation_rule_id>/cgi-bin/dca/realest.cgi</validation_rule_id>
<validation_rule_type>useparms</validation_rule_type>
<method>GET</method>
<argument_list>

<argument>

<name>item</name>
<validation_value_type>constant</validation_value_type>
<validation_value>money</validation_value>

</argument>
<argument>

<name>item</name>
<validation_value_type>input</validation_value_type>

</argument>
<argument>

<name>item</name>
<validation_value_type>all</validation_value_type>

</argument>
</argument_list>

</validation_rule>

Table 5 delineates an exemplary list of common commands that can be used in constructing web event/invalidation rules in accordance with an embodiment of the present invention.

TABLE 5
Web Event Rule Parameters

| Parameter | Definition |
|---|---|
| <validation_rule_id> | The id of the validation rule. This will be the <validation_rule_id> in the |
| | <validation_rule> |
| <dependency> | A list of dependency rules used to invalidate pages upon receiving this web |
| | event rule. |

The following is an example of web event rules formulated using the web event parameters of Table 5:

<web_event_rule>

<abs_path>/cgi-bin/dca/gener.cgi</abs_path>
<web_event_rule_id>updateGener</web_event_rule_id>
<method>POST</method>
<cookie_list>

<cookie>

<name>md</name>
<cacheable>Optional</cacheable>

</cookie>

</cookie_list>
<header_list>

<header>

<name>md</name>
<value>a_header</value>
<cacheable>MustNotBePresent</cacheable>

</header>

</header_list>
<argument_list>

<argument>

<name>md</name>
<cachcable>MustBePresent</cacheable>

</argument>

</argument_list>
<dependency>

<validation_rule_id>invalid_gener</validation_rule_id>

</dependency>

</web_event_rule>

Alternatively, the DCA server 420 can utilize the separate cache server 450 to determine the status of the content. For example, the DCA server 420 can use a proprietary interface of the cache server 450 to actively invalidate “stale” cached content. For example, the cache server 425 may utilize time-to-live techniques to invalidate cached contents. That is, when certain pre-determined time has transpired, the cache content is marked “invalid” and the invalidated cached content is replaced or “refreshed” with corresponding content by the application server 430. Since the status of the cached content is known, the DCA server 420 can serve “fresh” content without verifying the status of the content with the application server 430.

Typically, the end-user will receive no response if the cached content is determined to be “stale” at step 582 and there is a backend failure wherein either the application server 430 or the database 440 is unavailable. In such situation, it may preferable for the web site owner or web server 400 to serve “stale” content then no content. In accordance with an embodiment of the present invention, the DCA server 420 serves “stale” content if the web server 400 is unavailable to retrieve “fresh” content due to backend failure and replaces its “stale” content when the backend failure is resolved.

The response or requested web page may contain dynamic components. The dynamic component or data are generally transient in nature, e.g., latest weather reports, appointment calendars, auction catalogs, airline tickets sales and the like, because it is based on personalized or constantly changing information. Dynamic web content requires web server 400 and/or application server 430 to uniform resource locator (URL) of the request, the customized response can depend on additional parameter values included in the request, such as date and time, identity of the client or end-user, location of the client, etc. In accordance with an embodiment of the present invention, the DCA server 420 utilizes object caching to cache web content containing dynamically generated HTML without having to know how such dynamic component was created (i.e., a black box). The DCA server 420 caches the web page without caching the dynamic or page component (i.e., components of the web page that are unique for each instance) of the web page. That is, the DCA server utilizes object cache tags that are embedded in the HTML to tag the page components of the cached web page. The object cache tags instruct the DCA server 420 to retrieve a URL for inclusion into the web page before serving the requested content in response to client requests and to strip out sections of HTML (i.e., dynamic or page components) before the content is stored in the cache 425. The following is an exemplary list of the object cache tags in accordance with an embodiment of the present invention:

a) the “include” tag: <WARP:include URL> where URL is another URL to fetch for inclusion into the page at this point; and

b) the “nocache” tags: <WARP:nocache URL> instructs the DCA server 420 to remove the HTML that is wrapped in the nocache tags before it is cached. When the cached copy is served, the DCA server 420 requests the URL and includes the results between the nocache tags. </WARP:nocache> terminates the block of HTML that is not to be cached.

In accordance with an embodiment of the present invention, the DCA server 420 can use the “include” tag in a “template” to generate the content or generate the content with the “nocache” tags which allows the first generated page to be delivered to the web browser residing in the client computer 18. Alternatively, the DCA server 420 can elects to disable caching of web pages containing dynamic or page components. Page components are differentiated by their full uniform resource identifier (URI) including the query string, such that number of dynamically generated pages can be cached that contain object cache tags as long as their query strings differ. By breaking up the web pages into components, the DCA server 420 can selectively pick and choose which components will be cached and not cached.

When the DCA server 420 receives requests for such cached dynamic web pages or content, the DCA server 420 scans and parses the requested cached page for any object code tags. If object code tags are found in the requested cached page, the DCA sever 420 requests the dynamic or page component(s) from the application server 430 for inclusion in the web page to be served to the client via the web server 400. In accordance with an embodiment of the present invention, the application server 430 can include a plug-in source manager process 435 to perform in-line object caching. The source manager process 435 processes the object code tags from the DCA server 420 and generates the source page for new URL based on the received object code tags and the original page source (i.e., the dynamic web page or content). If no object code tags are found in the requested cached page, the DCA server 420 then sends the requested cached content to the web server 400 to be forwarded to the client.

However, if there is no cached copy of the requested dynamic web page or content, the DCA server 420 then sends the request back to the web server 400 so it can retrieve the requested dynamic web page from the application server 430. The web server 400 sends the retrieved requested dynamic web page to the client machine 18 and the DCA server 420 for storage in the cache 425. Upon receipt of the requested dynamic web page for caching, the DCA server 420 parses the dynamic web page and utilizes the object code tags, e.g., “include” and/or “nocache” tags, to identify one or more dynamic or page components of the web page. It is appreciated that data cannot be passed to a page component and any information that is necessary to generate various data of the page component must reside within that page component. This is because the cached page containing the object code tag(s) will have different information and will be generally out of context with the data needed by the page component, e.g., time, stock quotes, etc.

The following example details the use of the “include” tag in accordance with an embodiment of the present invention. Main.asp generates a template that is cached which contains the “include” object cache tag. When serving a cached copy of the requested page or content, the DCA server 240 requests http://example.org/pagecomponent.asp and replaces the object code tag(s) with the results before it is returned to the web server 400 to be delivered the web browser of the client machine 18.

<html>
<body>

<% do a bunch of stuff that generates a table %>

</body>
</html>

Cached results of the original page as stored in the cache 425:

<html>
<body>

some html
<table>
<tr> some html </tr>
<tr>
<WARP:include http://example.org/pagecomponent.asp>
</tr>
</table>

</body>
</html>

The results of serving a cached copy:

<html>
<body>

some html
<table>
<tr> some html </tr>
<tr>
This is the result of the “include” tag - the time is now 4:25 PM
</tr>
</table>

</body>
</html>

The following example details the use of the nocache tag in accordance with an embodiment of the present invention. The DCA server 420 can serve the dynamically generated page without any additional processing the first time that it is generated. With caching turned off, the DCA server 420 serves the dynamically generated page containing nocache tag(s), which is ignored by the web browser of the client machine 18. When the page is recovered or retrieved from the cache 425, the DCA server 420 requests http://example.org/pagecomponent.asp and replaces the nocache tag pair. It is appreciated that the DCA server 420 strips the HTML that resides between the nocache tag pair of the dynamically generated page before caching it in the cache 425.

Original .asp page:

<html>
<body>

<% server.execute pagecomponent.asp%>

</body>
</html>

Results of the original page:

<html>
<body

some html
<table>
<tr> some html </tr>
<tr>
<WARP:nocache http://example.org/pagecomponent.asp>
The stock is now at $3.50
</WARP:nocache>
</tr>
</table>

</body>
</html>

Cached results of the original page as stored in the cache 425:

<html>
<body>

some html
<table>
<tr> some html </tr>
<tr>
<WARP:nocache http://example.org/pagecomponent.asp>
<WARP:nocache>
</tr>
</table>

</body>
</html>

The results of serving a cached copy:

<html>
<body>

some html
<table>
<tr> some html </tr>
<tr>
The stock is now at $3.70.
</tr>
</table>

</body>
</html>

During the time a backend server, such as the application server 430 or database server 440, is generating the requested content in response to a client request, the web server 400 and/or the DCA server 420 may receive additional requests for same content. In accordance with an embodiment of the present invention, the DCA server 420 queues the subsequent requests in a request queue 424 instead of forwarding them to the application server 430 via the web server 400. This advantageously minimizes the flooding of the application server 430 and the database server 440 with requests for the same content, especially during peak time, thereby reducing the latency and the load on the application server 430 and the database server 440. When the requested content becomes available from the cache 425, the DCA server 420 responds to each request stored in the request queue 424 with a cached copy of the requested content. In accordance with an embodiment of the present invention, the DCA server 420 adds a placeholder in the cache, particularly in the cache index, and the entry is flagged (i.e., a content retrieval flag) that the content is being retrieved. When the DCA server 420 receives subsequent multiple requests for the same content, the DCA server 420 will find an entry in the cache when it performs a cache lookup. Since, the content retrieval flag is “on,” the DCA server 420 holds or stores the subsequent multiple requests in the request queue 424.

The security of a web site is generally handled by the web server 400 or the application server 430 employing an authentication techniques to control the access of certain content or web pages to only authorized users. However, currently available caching system can circumvent such authentication techniques employed by the application server 430. In accordance with an embodiment of the present invention, the DCA server 420 utilizes authentication rules to augment or solve the problems of the existing authentication process. The DCA server 420 can query a directory service or the application server 430 before serving a cached copy of the requested content. Preferably, the DCA server 420 maintains the client's authentication information to serve the cached content to only authorized users.

When a client or end-user accesses a web site or web server 400, a session is established for the client. Typically, the web server 400 can establish a user session using a cookie or session field in the query string, i.e., URL rewrite. It is appreciated that the new session may not have access right until the client is authorized by the authentication process. Generally, the client enters user id and password on the web browser of the associated client machine 18, which transmits' them together with the client request to the application server 430 via the web server 400. The application server 430 then authenticates the client using any known techniques, such as traditional database authentication, lightweight directory access protocol (LDAP), or other directory service. Once the client is authenticated, the application server 430 sets the user session as being a valid session and assigns a session id. In accordance with an embodiment of the present invention, the DCA server 430 captures and stores the session id in a session id table (not shown). The DCA server 430 only provides the cached content to clients having valid session ids, thereby maintaining the secured access to the web site even when the content is served from the cache 425.

The DCA server 430 captures the client's login request and examines the response to such login request from the application server 430. Once the session is verified as being valid, the DCA server 430 adds the session id to the session id table. For each request for content, the DCA server 430 searches the session id table to determine if the session associated with the request is valid and serves the cached content to only session with a valid entry in the session table. The session id is removed from the session id table when the DCA server 430 determines that the corresponding session has terminated. Alternatively, the DCA server can prune the session id table based on various factors, such as maximum life of a session, idle time of a session, close out of a session, etc.

In accordance with an embodiment of the present invention, the system employs two levels of caching (i.e., level 2 caching). The cache 425 of the DCA server 430 is augmented with a local cache or data store 22 (FIG. 1) which resides in each web server 400. Local cache is based on highest hit count. That is, the most frequently accessed web pages of the web server 400 are stored in the local cache 22, which can be configurable. To administer and maintain accurate access log and access count, the DCA plug-in 410 of the web server 400 sends a one-way token to the DCA server 430 when the requested content resides in the local cache 22. Upon receipt of the one-way token, the DCA server 430 uses the token to write to access log and increase the access count. It is appreciated that the local cache 22 as used in the level 2 caching in accordance with an embodiment of the present invention operates similarly to the cache 425 in the DCA server. When the web server 400 receives a request for content in step 500, the DCA plug-in 410 determines if the requested content is in its local cache 22. If the DCA plug-in 410 determines that the requested content is in the local cache 22, the DCA plug-in 410 forwards the locally cached content to the client or directs the web server 400 to forward the locally cached content to the client. However, if the DCA plug-in 410 determines that the requested content is not available from the local cache 22, it forwards the request to the DCA server 420 for processing. The DCA server 430 maintains entries for all locally cached page, i.e., flags all locally cached pages. That is, the cache 425 maintains a local cached flag for all locally cached pages or contents. This enables the DCA server 430 to send invalidation requests to the appropriate DCA plug-in 410 when a locally cached page is invalidated. Preferably, the DCA server 420 maintains a collection of socket connections from each DCA plug-in 410 to send invalidation request to each DCA plug-in 410.

The following is an exemplary implementation of the DCA plug-in 410 in accordance with an embodiment of the present invention. It is appreciated that the DCA plug-in 410 can use the same classes as in DCA server 420 to hold cached content. In addition, a LocalCacheMinCount count is maintained, which represents the lowest hit count among the locally cached pages.

Upon processing request, the DCA plug-in searches the local cache 22 first, If a match found

{

return the local content back to client
// increments the count
LocalCacheMinCount = max(hit count of the page,
LocalCacheMinCount)
Send a count request to DCA server 420

}
else // not in local cache
{

nothing new needs to be done

}

Upon receipt of a cached content from DCA server, the following algorithm can be used for determine if the page should be cached locally in the local cache 22:

If there is room in the local cache 22

{

add the new content to local cache 22
Update the LocalCacheMinCount

}
else If (HitCount in DCAContent is more than LocalCacheMinCount)
{

// need purge some page out
remove the page with hitCount of LocalCacheMinCount
Add new page in local cache
Update the LocalCacheMinCount

}
else
{

nothing new needs to be done

}

Implementations of the invention may include a computer system programmed to execute a method of the invention. The invention may also be provided in the form of a program product. The program product may comprise any medium which carries a set of computer-readable signals corresponding to instructions which, when run on a computer, cause the computer to execute a method of the invention. The program product may be distributed in any of a wide variety of forms. The program product may comprise, for example, physical media such as floppy diskettes, CD ROMs, DVDs, hard disk drives, flash RAM or the like or transmission-type media such as digital or analog communication links. The invention includes the broad structures, apparatus, methods, and arrangements discussed herein as well as the details of implementation and combinations of details of implementation, which are discussed herein.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A computer-implemented method for optimizing web servers, comprising the steps of:
receiving a request for dynamic content from a client over a communications network by a web server;
sending said request to a centralized cache server for determining whether a copy of said dynamic content is available from a cache over said network;
receiving a cached copy of said dynamic content from said centralized cache server over said network if it is determined that said dynamic content is available from said cache of said centralized cache server;
transmitting said request to an application server over said network if it is determined that said dynamic content is not available from said cache;
receiving a copy of said dynamic content from said application server over said network;
transmitting said copy of said dynamic content received from said application server to said centralized cache server over said network; and
storing said copy of said dynamic content in said cache by said centralized cache server.

2. The method of claim 1, wherein the step of transmitting said copy comprises the steps of:
modifying said copy of said dynamic content to provide a modified copy by said web server; and
transmitting said modified copy to said centralized cache server over said network.

3. The method of claim 2, wherein the step of modifying includes the step of adding caching instructions to said copy of said dynamic content.

4. The method of claim 1, wherein the step of transmitting said copy comprises the step of selectively sending said copy of said dynamic content based on pre-determined caching rules over said network.

5. The method of claim 4, further comprising the steps of:
monitoring said requests to said web server to determine a recommended list of caching rules for an administrator of said web server; and
selecting by said administrator one or more of said caching rules from said recommended list to provide dynamic caching rules; and
wherein the step of selectively sending said copy selectively sends said copy of said dynamic content based on said dynamic caching rules.

6. The method of claim 1, wherein the step of receiving a cached copy comprises the steps of:
determining if said cached copy of said dynamic content is fresh;
receiving said cached copy of said dynamic content from said centralized cache server over said network if it is determined that said cached copy is fresh; and
transmitting said request to said application server via said web server over said network if it is determined that said cache copy is stale.

7. The method of claim 6, wherein the step of determining comprises the step of determining if said cached copy is fresh based on pre-determined validation rules.

8. The method of claim 6, further comprising the step of invalidating said cached copy of said dynamic content based on pre-determined invalidation rules.

9. The method of claim 6, wherein the step of receiving a cached copy further comprises the step of receiving said cached copy of said dynamic content from said centralized cache server over said network if it is determined that said cached copy is stale and said application server is unavailable.

10. The method of claim 1, wherein the step of transmitting said copy comprises the step of tagging page components of said dynamic content with object code tag pairs if said dynamic content is dynamically generated content; and wherein the step of receiving a cached copy comprises the steps of:
parsing said cached copy of said dynamic content for said object code tag pairs by said centralized cache server;
requesting corresponding page components from said application server by said centralized cache server over said network if it is determined that said cached copy includes said object code tag pairs;
generating said dynamically generated content from said page components and said cached copy by said centralized cache server; and
receiving said dynamically generated content from said centralized cache server over said network.

11. The method of 1, wherein the step of transmitting said copy comprises the step of tagging page components of said requested dynamic content with object code tag pairs if said dynamic content is dynamically generated content; and wherein the step of receiving a cached copy comprises the steps of:
parsing said cached copy of said dynamic content for said object code tag pairs by said centralized cache server;
requesting said dynamically generate content from said application server by said centralized cache server over said network if it is determined that said cached copy includes said object code tag pairs;
generating said dynamically generated content from said object code tag pairs and said dynamic content by said application server; and
receiving said dynamically generated content from said application server by said centralized cache server over said network.

12. The method of claim 1, further comprising the steps of:
authenticating said client to determine if said client is authorized to receive said dynamic content;
establishing a session and assigning a session id for said client if it is determined that said client is authorized to receive said dynamic content;
storing said session id by said centralized cache server; and
receiving said cached copy of said dynamic content if it is determined that said dynamic content is available from said cache of said centralized cache server and said session id associated with said client matches one of said stored session id.

13. The method of claim 1, further comprising the steps of:
determining if said dynamic content is available from a local cache by said web server;
transmitting a locally cached copy of said dynamic content to said client if it is determined that said dynamic content is available from said local cache; and
sending said request to said centralized cache server if it is determined that said dynamic content is not available from said local cache.

14. A system for optimizing web servers connected to a communications network, comprising the steps of:
a web server for receiving a request for dynamic content from a client over said network;
a centralized cache server for determining whether a copy of said dynamic content is available from a cache, transmitting a cached copy of said dynamic content to said web server over said network if it is determined that said dynamic content is available from said cache, transmitting said request to an application server via said web server over said network if it is determined that said dynamic content is not available from said cache; and
an application server for transmitting a copy of said dynamic content to web server over said network if it is determined that said dynamic content is not available from said cache; and
wherein said web server is operable to transmit said copy of said dynamic content received from said application server to said centralized cache server over said network; and
wherein said centralized cache server is operable to store said copy of said dynamic content in said cache.

15. The system of claim 14, wherein said web server comprises a plug-in process for modifying said copy of said dynamic content to provide a modified copy and transmitting said modified copy to said centralized cache server over said network.

16. The system of claim 15, wherein said plug-in process is operable to add caching instructions to said copy of said dynamic content.

17. The system of claim 14, wherein said centralized cache server is operable to determine if said cached copy of said dynamic content is fresh, transmitting said cached copy of said dynamic content to said web server over said network if it is determined that said cached copy is fresh, and transmitting said request to said application server via said web server over said network if it is determined that said cache copy is stale.

18. The system of claim 14, wherein said centralized cache server is operable to tag page components of said dynamic content with object code tag pairs if said dynamic content is dynamically generated content; parse said cached copy of said dynamic content for said object code tag pairs; request corresponding page components from said application server over said network if it is determined that said cached copy includes said object code tag pairs; generate said dynamically generated content from said page components and said cached copy; and transmit said dynamically generated content to said web server over said network.

19. A computer readable medium comprising code for optimizing web servers, said code comprising instructions for:
receiving a request for dynamic content from a client over a communications network by a web server;
sending said request to a centralized cache server for determining whether a copy of said dynamic content is available from a cache over said network;
receiving a cached copy of said dynamic content from said centralized cache server over said network if it is determined that said dynamic content is available from said cache of said centralized cache server;
transmitting said request to an application server over said network if it is determined that said dynamic content is not available from said cache;
receiving a copy of said dynamic content from said application server over said network;
transmitting said copy of said dynamic content received from said application server to said centralized cache server over said network; and
storing said copy of said dynamic content in said cache by said centralized cache server.

20. The computer readable medium of claim 19, wherein said code further comprises instructions for:
determining if said cached copy of said dynamic content is fresh;
receiving said cached copy of said dynamic content from said centralized cache server over said network if it is determined that said cached copy is fresh; and
transmitting said request to said application server via said web server over said network if it is determined that said cache copy is stale.
